(19) United States
(12) Patent Application Publication
(10) Pub. No.: US 2008/0075420 A1
(43) Pub. Date: Mar. 27, 2008

(54) Recording and reproducing apparatus

(75) Inventor: Teruyuki Yamagishi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/898,738

(22) Filed: Sep. 14, 2007

(30) Foreign Application Priority Data
Sep. 27, 2006 (JP) 2006-261886

(51) Int. Cl. H04N 5/91

(52) U.S. Cl. 386/68; 386/E05.001

(57) ABSTRACT

A recording and reproducing apparatus using an overwritable recording medium and chapter setting is mechanized is equipped with a recording unit that records play position information on the recording medium, the information indicating a play position of at least one timing selected from the timings when an operation is made for changing from a normal play action to a predetermined action except the normal play action, and when the predetermined action changes to the normal play action after that.

This application is based on Japanese Patent Application No. 2006-261886 filed on Sep. 27, 2006, the contents of which are hereby incorporated by reference.

### BACKGROUND OF THE INVENTION

1. Field of the Invention

The present invention relates to a recording and reproducing apparatus such as a hard disk recorder or the like.

2. Description of Related Art

Some of the conventional recording and reproducing apparatuses such as hard disk recorders, DVD recorders or the like, which are overwritable, have a chapter setting function for setting a chapter (or a chapter number) as a target point for fast forward play, reverse play and the like in video information. If a user wants to set a chapter in video information that is already recorded on the recording medium by using such an apparatus, the user should first start normal play or start play after entering an edit mode. Then the user may press a chapter setting button on a remote controller so as to set the chapter (see JP-A-2002-152636, for example, as to setting of a chapter after entering the edit mode).

However, according to the chapter setting method described above, a chapter cannot be set unless the user starts a chapter action intentionally. For example, the user should press the chapter setting button during the normal play before performing the fast forward play, the reverse play, CM skip or the like, and the user should press the chapter setting button again after the fast forward play, the reverse play, the CM skip or the like. So, there is a problem that these operations are burdensome for users.

### SUMMARY OF THE INVENTION

In view of the above described problems, it is an object of the present invention is to provide a recording and reproducing apparatus that enables unconscious chapter setting that matches user's taste without requiring the user to do the burdensome and conscious chapter setting as the conventional method.

To attain the above described object a recording and reproducing apparatus in accordance with a first aspect of the present invention uses an overwritable recording medium, and the recording and reproducing apparatus is characterized by a structure in which the apparatus is equipped with a recording unit that records play position information on the recording medium, the information indicating a play position of at least one timing selected from the timings when an operation is made for changing from a normal play action to a predetermined action except the normal play action, and when the predetermined action changes to the normal play action after that.

According to this structure, chapter setting that is adapted to the user's taste can be performed even if the user is unconscious about it, so that the user is not bothered by conscious chapter setting as the conventional method.

Further, a recording and reproducing apparatus in accordance with a second aspect of the present invention is characterized by a structure in which the predetermined action is at least one of a pause action, a stop action, a skip action, a fast forward play action and a reverse play action in the above described recording and reproducing apparatus according to the first aspect of the present invention.

Still further, a recording and reproducing apparatus in accordance with a third aspect of the present invention is characterized by a structure in which the change of action is made by a user's operation in the above described recording and reproducing apparatus according to the second aspect of the present invention.

Still further, a recording and reproducing apparatus in accordance with a fourth aspect of the present invention is characterized by a structure in which the change of action is based on end of the predetermined action in the above described recording and reproducing apparatus according to the second aspect of the present invention.

According to the recording and reproducing apparatus of the present invention, chapter setting that is adapted to the user's taste can be performed even if the user is unconscious about it, so that the user is not bothered by conscious chapter setting as the conventional method.

Other advantages and features of the present invention will become apparent from the following description of the preferred embodiment.

### BRIEF DESCRIPTION OF THE DRAWINGS

FIG. 1 is a block diagram of a hard disk recorder as an example of a recording and reproducing apparatus according to the present invention.

FIG. 2 is a flowchart to show an example of a chapter setting action of the hard disk recorder shown in FIG. 1.

FIG. 3 is a diagram to show an example of the chapter setting action performed by the hard disk recorder shown in FIG. 1.

### DETAILED DESCRIPTION OF THE PREFERRED EMBODIMENTS

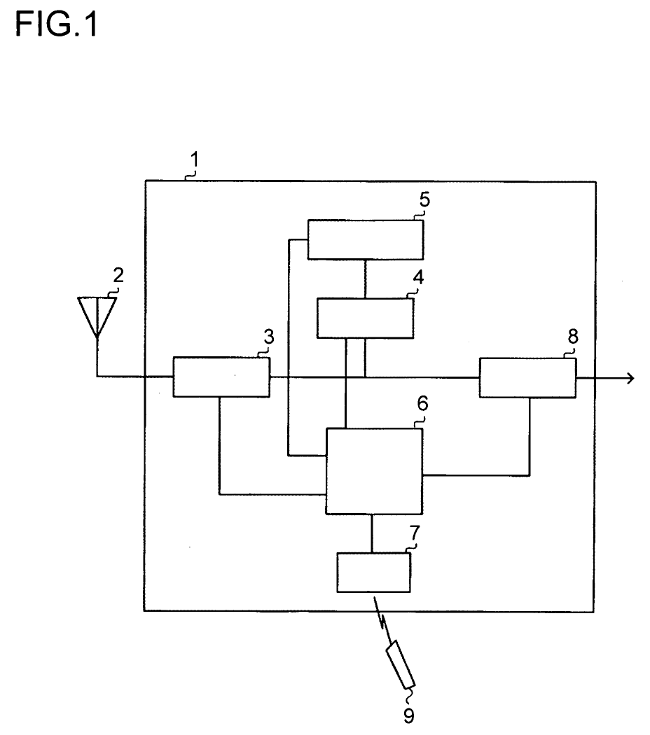

Hereinafter, an embodiment of the present invention will be described with reference to the attached drawings. FIG. 1 is a block diagram of a hard disk recorder 1 as an example of a recording and reproducing apparatus according to the present invention.

An antenna 2 receives broadcasting radio waves and delivers them to a tuner 3. The tuner 3 extracts a high frequency signal of a channel designated by a control unit 6 from high frequency signals received by the antenna 2 and delivers video information thereof.

An MPEG codec 4 compresses video information from the tuner 3 and expands compressed video information that is read out from a hard disk by a hard disk drive 5. The hard disk drive 5 stores the video information compressed by the MPEG codec 4 on its internal hard disk and read out the compressed video information from the hard disk.

An on screen display (OSD) unit 8 generates graphic information and character information in accordance with an instruction from the control unit 6 and combines the graphic information and the character information with the video information supplied from the tuner 3 or the MPEG codec 4 so as to generate a composite signal. This composite signal is converted into a video signal, which is delivered to a display device of a television set or the like (not shown). In addition, the OSD unit 8 converts only the graphic information and the character information into the video signal and delivers it to the display device.

The remote controller receiving unit 7 receives an infrared signal from the remote controller 9 and converts it into a code signal, which is delivered to the control unit 6.

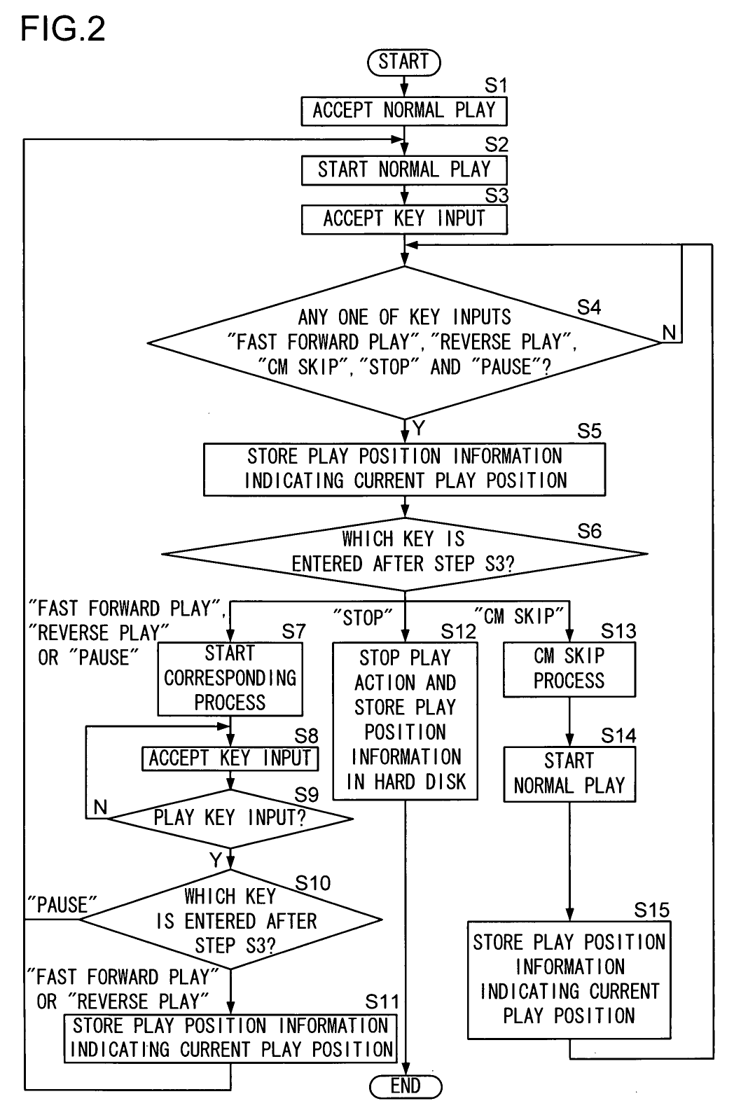

As to the hard disk recorder 1 having this structure, a chapter setting action for setting chapters in video information that is already recorded on the hard disk will be described with reference to a flowchart shown in FIG. 2.

FIG. 2 is a flowchart to show an example of the chapter setting action of the hard disk recorder shown in FIG. 1. In the step S1, the remote controller 9 issues an instruction of normal play, which is received by the control unit 6. In the step S2, the hard disk drive 5 starts to read video information recorded on the hard disk in response to the instruction from the control unit 6, and the read video information is delivered as a video signal to the display device (not shown) via the MPEG codec 4 and the OSD unit 8, so that the normal play is started.

In the step S3, the control unit 6 becomes a state where key input can be accepted in the remote controller 9. In the step S4, the control unit 6 decides whether or not any one of an instruction of fast forward play, an instruction of reverse play, an instruction of CM skip, an instruction of stop and an instruction of pause is entered with the remote controller 9. If it is decided that any one of the instruction of fast forward play, the instruction of reverse play, the instruction of CM skip, the instruction of stop and the instruction of pause is not entered (N in the step S4), the process goes back to the step S3, in which the control unit 6 becomes the state where a key input is acceptable.

If it is decided in the step S4 that one of the instruction of fast forward play, the instruction of reverse play, the instruction of CM skip, the instruction of stop and the instruction of pause is entered (Y in the step S4), the process goes to the step S5. In the step S5, the control unit 6 stores play position information indicating a current play position obtained from the MPEG codec 4 in a memory (not shown).

Next in the step S6, the control unit 6 decides which one of a fast forward play key, a reverse play key, a CM skip key, a stop key and a pause key is the key that is entered after the control unit 6 becomes the state where a key input is acceptable in the step S3.

If it is decided that the key entered in the step S6 is one of the fast forward play key, the reverse play key and the pause key, the process goes to the step S7, in which a process corresponding to the key is started. If the entered key is the fast forward play key or the reverse play key, the hard disk drive 5 starts to read the video information recorded on the hard disk skipping addresses in accordance with an instruction from the control unit 6, so that the fast forward play or the reverse play is started. In addition, if the entered key is the pause key, the hard disk drive 5 stops the reading in accordance with an instruction from the from the control unit 6, and the OSD unit 8 starts to deliver continuously a video signal of the same frame in accordance with an instruction from the control unit 6. Thus, so-called still play is started, so that a still image is displayed on the display device.

After the step S7, the control unit 6 becomes the state where a key input on the remote controller 9 is accepted in the step S8, and the control unit 6 decides whether or not an instruction of play is entered in the remote controller 9 in the step S9. If it is decided that the instruction of play is not entered (N in the step S9), the process goes back to the step S8, in which the control unit 6 becomes the state where a key input can be accepted.

If it is decided that the instruction of play is entered (Y in the step S9), the process goes to the step S10, in which the control unit 6 decides which one of the fast forward play key, the reverse play key and the pause key is the key that is entered after the control unit 6 becomes the state where a key input can be accepted in the step S3.

If it is decided that the pause key is entered in the step S10, the process goes back to the step S2, in which the hard disk drive 5 starts to read the video information from the address in which the reading is stopped in the step S7, responding to an instruction from the control unit 6, so that the normal play is started.

If it is decided that the fast forward play key or the reverse play key is entered in the step S10, the process goes to the step S11, in which the control unit 6 stores play position information indicating a current play position obtained from the MPEG codec 4 in a memory (not shown). Then, the process goes back to the step S2, in which the hard disk drive 5 starts normal reading of the video information from the current address in response to an instruction from the control unit 6, so that the normal play is started.

If it is decided that the entered key is the CM skip key in the step S6, the process goes to the step S13, in which the hard disk drive 5 makes access to the address corresponding to a play position a predetermined time after (e.g., 30 seconds after) the current play position in response to an instruction from the control unit 6. In the step S14, the hard disk drive 5 starts normal reading of the video information from the address that is accessed in the step S13, so that the normal play is started.

In the step S15, the control unit 6 stores the play position information indicating the current play position obtained from the MPEG codec 4 in a memory (not shown). Then, the process goes back to the step S3, in which the control unit 6 becomes the state where a key input can be accepted.

If it is decided that the entered key is the stop key in the step S6, the process goes to the step S12, in which the hard disk drive 5 stops the reading of the video information in response to an instruction from the control unit 6 so that the play action is stopped. The hard disk drive 5 stores all the play position information stored in the memory (not shown) in the hard disk responding to an instruction from the control unit 6, so that chapters are set in the video information based on the play position information recorded in the hard disk.

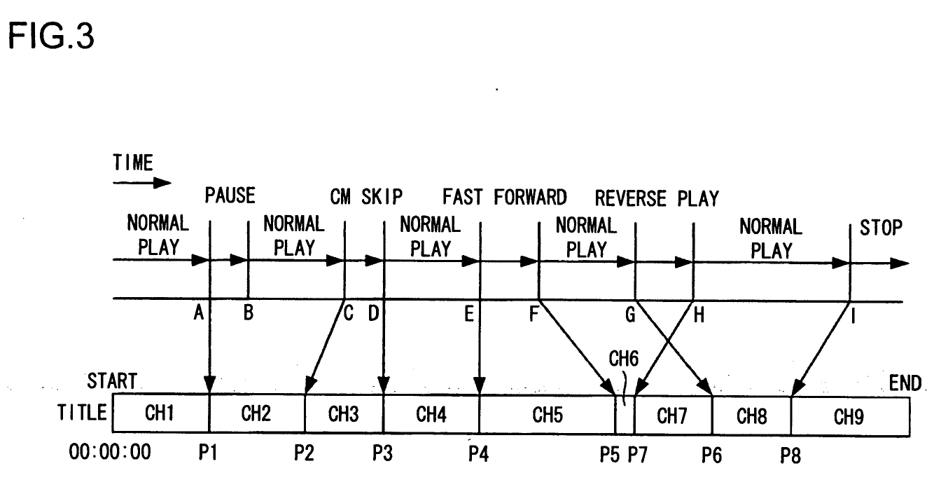

FIG. 3 shows an example of the chapter setting action performed by the hard disk recorder shown in FIG. 1. The lower part of FIG. 3 shows a title that is video information.

After the remote controller 9 issues an instruction of normal play in the step S1 and the normal play starts in the step S2, the instruction of pause is entered at the timing A. Then, the play position information indicating the current play position P1 is stored in the memory in the step S5. Then, a still play is started in the step S7, and after that, when the instruction of play is entered with the remote controller 9 at the timing B, the normal play is started in the step S2.

After that, when the instruction of CM skip is entered with the remote controller 9 at the timing C, the play position information indicating the current play position P2 is stored in the memory in the step S5. Then, the normal play is started from the position in which a predetermined time of picture is skipped in the step S14, the play position information indicating the current play position P3 is started in the memory in the step S15.

After that, when the instruction of fast forward play is entered with the remote controller 9 at the timing E, the play position information indicating the current play position P4 is stored in the memory in the step S5. Then, the fast forward play is started in the step S7. After that, when the instruction of play is entered with the remote controller 9 at the timing F, the play position information indicating the current play position P5 is stored in the memory in the step S11. Then, the normal play is started at the step S2.

After that, when the instruction of reverse play is entered with the remote controller 9 at the timing G, the play position information indicating the current play position P6 is stored in the memory in the step S5. Then, the reverse play is started in the step S7. After that, when the instruction of play is entered with the remote controller 9 at the timing H, the play position information indicating the current play position P7 is stored in the memory in the step S11. Then, the normal play action is started in the step S2.

After that, when the instruction of stop is entered with the remote controller 9 at the timing I, the play position information indicating the current play position P8 is stored in the memory in the step S5. Then, the play action stopped in the step S12, and each of the play position information indicating all the play positions P1-P8 stored in the memory are recorded on the hard disk. Thus, nine chapters CH1-CH9 are set in one title.

In this way, according to the present invention, chapters can be set only if the user enters the instruction of pause, the instruction of CM skip, the instruction of fast forward play, the instruction of reverse play, the instruction of play or the instruction of stop for canceling the fast forward play and the reverse play. Therefore, chapter setting that is adapted to the user's taste can be performed even if the user is unconscious about it, so that the user is not bothered by conscious chapter setting as the conventional method.

Although the play position information indicating the play position when the instruction of pause is entered is recorded on the hard disk in the above-mentioned embodiment, it is possible to adopt another structure in which the play position information indicating the play position when the instruction of play is entered for canceling the paused state is recorded on the hard disk. In addition, it is possible adopt another structure in which the play position information indicating the play positions when the instruction of pause is entered and when the instruction of play is entered for canceling the paused state is recorded on the hard disk.

Although the play position information indicating play positions when the instruction of CM skip is entered and when the normal play is started after the CM skip action is finished is recorded on the hard disk in the above-mentioned embodiment, it is possible to adopt another structure in which only the play position information indicating the play position when the normal play is started after the CM skip action is finished is recorded on the hard disk.

Note that the present invention can be applied to any recording and reproducing apparatus that uses any type of disc that is overwritable, including a DVD recorder, a Blu-ray Disc (BD) recorder and the like, without limiting to the hard disk recorder in the above-mentioned embodiment.

What is claimed is:

1. A recording and reproducing apparatus that uses an overwritable recording medium, wherein
the apparatus is equipped with a recording unit that records play position information on the recording medium, the information indicating a play position of at least one timing selected from the timings when an operation is made for changing from a normal play action to a predetermined action except the normal play action, and when the predetermined action changes to the normal play action after that.

2. The recording and reproducing apparatus according to claim 1, wherein the predetermined action is at least one of a pause action, a stop action, a skip action, a fast forward play action and a reverse play action.

3. The recording and reproducing apparatus according to claim 2, wherein the change of action is made by a user's operation.

4. The recording and reproducing apparatus according to claim 2, wherein the change of action is based on end of the predetermined action.
